(19) United States
(12) Patent Application Publication
(10) Pub. No.: US 2012/0010827 A1
(43) Pub. Date: Jan. 12, 2012

(54) FRICTION TEST APPARATUS AND METHODS FOR ANTIPERSPIRANT/DEODORANT PRODUCTS

(75) Inventor: Travis T. Yarlagadda, Phoenix, AZ (US)

(73) Assignee: The Dial Corporation, Scottsdale, AZ (US)

(21) Appl. No.: 12/832,147

(22) Filed: Jul. 8, 2010

(51) Int. Cl. G01N 19/02

(52) U.S. Cl. 702/41; 73/9

(57) ABSTRACT

A friction test system for an antiperspirant/deodorant (APDO) product generally includes a substrate having a test surface and a mount assembly configured to hold the APDO product in contact with the test surface and maintain an applied force between the APDO product and the test surface such that the applied force is substantially normal to the test surface. An actuator (e.g., a linear actuator) is configured to move the mount assembly laterally along an axis substantially perpendicular to the applied force during a testing mode. A force sensor is configured to determine the frictional force experienced by the APDO product during the testing mode. A processor coupled to the mount assembly, the actuator, and the force sensor, is configured to determine the coefficient of friction of the APDO product with respect to the test surface based on a ratio of the applied force and the frictional force.

### TECHNICAL FIELD

Embodiments of the subject matter described herein relate generally to the testing of antiperspirant/deodorant (APDO) products and, more particularly, to friction testing of such products.

### BACKGROUND

Both the efficacy and the user experience associated with the application of an antiperspirant/deodorant (APDO) product are dependant on a number of factors. One of these factors is the frictional force arising during application—i.e., the frictional force resulting from the APDO product being pressed against the skin and moved laterally.

Currently known methods of testing the effective coefficient of friction of an APDO product are unsatisfactory in a number of respects. For example, such systems often do not allow the product to be tested at a range of temperatures, angles, test surfaces, and applied pressure. Further, currently known systems may utilize counterbalance-based methods of applying pressure and be oriented in such a way that the force of gravity may cause inaccuracies in the applied force readings.

Accordingly, it is desirable to provide improved systems and methods of testing the friction characteristics of APDO products. Other desirable features and characteristics of the present invention will become apparent from the subsequent detailed description and the appended claims, taken in conjunction with the accompanying drawings and the foregoing technical field and background.

### BRIEF SUMMARY

A friction test system for an antiperspirant/deodorant (APDO) product in accordance with one embodiment generally includes a substrate having a test surface and a mount assembly configured to hold the APDO product in contact with the test surface and maintain an applied force between the APDO product and the test surface such that the applied force is substantially normal to the test surface. An actuator (e.g., a linear actuator) is configured to move the mount assembly laterally along an axis substantially perpendicular to the applied force during a testing mode. A force sensor is configured to determine the frictional force experienced by the APDO product during the testing mode. A processor coupled to the mount assembly, the actuator, and the force sensor, is configured to determine the coefficient of friction of the APDO product with respect to the test surface based on a ratio of the applied force and the frictional force.

A method in accordance with one embodiment includes: selectably securing a test surface to a test substrate; holding the APDO product in contact with the test surface; maintain an applied force between the APDO product and the test surface such that the applied force is substantially normal to the test surface; moving the APDO product laterally along an axis substantially perpendicular to the applied force; determining a frictional force experienced by the APDO product while the APDO product is moved laterally; and determining a coefficient of friction based on a ratio of the applied force and the frictional force.

A mount assembly for friction testing an antiperspirant/deodorant (APDO) product generally includes a base and a clamp assembly coupled to the base and configured to grasp the APDO product. A force actuator (e.g., an air cylinder) maintains an applied force between the APDO product and a test surface such that the applied force is substantially normal to the test surface and substantially perpendicular to the force of gravity. A linear bearing coupled between the base and the clamp assembly allows movement of the clamp assembly with respect to the base along an axis parallel to the applied force. A first force sensor (e.g., a load cell) is configured to determine a frictional force experienced by the APDO product as it is moved with respect to the test surface. A second force sensor (e.g., a load cell) is configured to measure the applied force produced by the force actuator.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a conceptual overview of a friction test system in accordance with one embodiment of the invention;

FIG. 2 is an isometric overview of an exemplary mount assembly;

FIG. 3 is an isometric overview of an exemplary test apparatus; and

FIG. 4 depicts sample graphical output in accordance with one embodiment.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to antiperspirants, deodorants, automated testing, and the like, are not described in detail herein.

Techniques and systems may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

The present invention relates to friction testing of antiperspirant/deodorant (APDO) products and/or subcomponents—that is, the frictional force arising from pressing a surface of the APDO product against another surface (e.g., human skin) and moving the APDO product laterally across that surface. In this regard, the term “APDO” as used herein refers to any solid, gel, or hybrid material of the type that may be used in connection with antiperspirants and/or deodorants. As is known, such materials might include various combinations of antimicrobials, alcohols, essential oils, perfumes, powders, aluminum-based compounds, and the like, and are generally frangible in that they leave behind a layer of material on the skin, thereby providing the desired antiperspirant and/or deodorant effect. And while the present invention is described in the context of such products, it will be appreciated that systems and methods in accordance with the present invention may be used to provide friction characteristics of other, similarly frangible products.

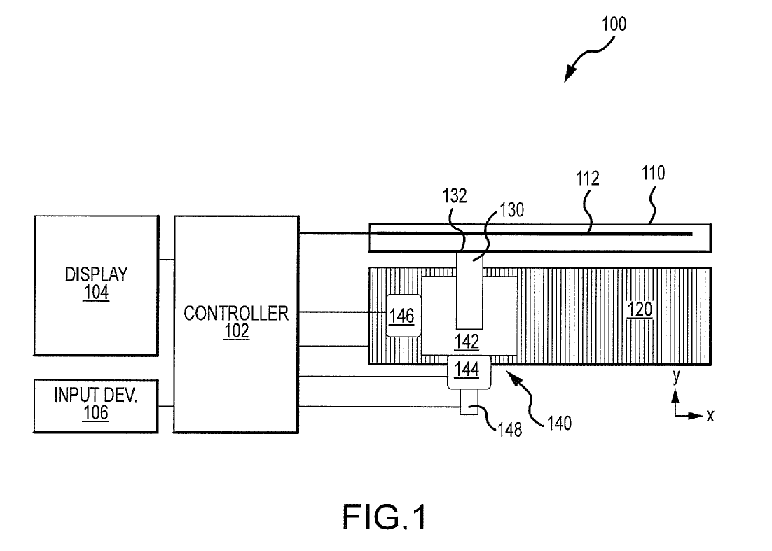

Referring to the conceptual block diagram shown in FIG. 1, a friction testing system (or simply “system”) 100 in accordance with an exemplary embodiment generally includes a controller 102 (e.g., CPU, microcontroller, etc.) coupled to a display (e.g., a monitor) 104, and one or more input devices (e.g., keyboard, mouse, trackball, etc.) 106. Controller 102 is coupled to a mount assembly 140 that rigidly holds an APDO product (or simply “product”) 130 in place with respect to mount assembly 140, and which also allows product 130 to be positioned with respect to (and pressed against) a test surface 132 of substrate 110.

Controller 102 is further coupled to a heating element 112 incorporated into substrate 110. A linear actuator 120, also coupled to controller 102, is configured to cause translation of mount assembly 140 with respect to substrate 110. It will be understood that, in the interest of clarity and simplicity, various conventional system components may not be illustrated in FIG. 1, including, for example, motor control units, signal conditioners, communication cables, and the like.

While mount assembly 140 may have a variety of components and configurations, in the illustrated embodiment mount assembly 140 includes a longitudinal force actuator 148 mechanically coupled to product 130 through a force sensor 144, and a lateral force sensor 146 configured to sense the lateral force applied to product 130 during translation brought about by linear actuator 120.

Force sensor 144 is “longitudinal” in that it senses the normal force resulting from product 130 contacting substrate 110 (i.e., the force normal to the test surface 132 of substrate 110), while force sensor 146 is “lateral” in that it senses the force acting in a direction perpendicular to the normal force sensed by force sensor 144. Thus, force sensors 144 and 146 are themselves oriented substantially perpendicular to each other. In one embodiment, force sensor 144 and force actuator 148 are substantially coaxial.

The orientation of APDO product 130 with respect to substrate 110 may be constant, manually adjustable, or programmatically adjustable during a testing mode (i.e., via the use of a servo or other conventional angular control, not illustrated). For example, mount assembly 140 may be configured to position product 130 at discreet settings of 0 degrees (perpendicular), 10 degrees, 20 degrees, and 30 degrees with respect to the plane of substrate 110 (and test surface 132). The angle adjustment might also be continuous over a range of values.

While substrate 110 is depicted as planar, it may also be configured as a combination of planar, concave, and/or convex regions. Further, while it is advantageous for linear actuator 120 to be oriented orthogonal to the force of gravity (thereby providing more accurate force measurements from sensors 146 and 144), the invention is not so limited.

Controller 102 includes suitable hardware and software components for causing mount assembly 140 to translate laterally back and forth while pressing product 130 against substrate 110 with a known force, thereby applying the APDO product to test surface 132. For example, controller 102 may employ a closed-loop control module 103 (e.g., a hardware or software-implemented P-I-D control or P-D control scheme) to achieve a desired force set-point via force actuator 148 and force sensor 144.

The particular settings for the testing mode may be selected by an operator via input device 106, and the output of the test (in the form of graphs, tabular data, etc.) may be viewed via display 104. Test sequence settings may include, but are not limited to, linear actuator speed, applied normal force (force actuator 148), linear actuator travel (the extent of side-to-side movement), number of back-and-forth cycles, temperature of substrate 110, acceleration rate (i.e., for specifying constant or changing linear actuator speed), and data acquisition rate (samples per second).

By determining the resultant lateral force via sensor 146 during the testing mode, the coefficient of friction μ between product 130 and substrate 110 may be determined in real-time as product 130 is swept across test surface 132. More particularly, the coefficient of friction can, by definition, be found from the ratio of the frictional force (sensor 146) and the normal force (sensor 144). In this regard, the computed coefficient of friction may take into account any of the various subcategories of frictional effects, including fluid friction, dry friction, skin friction, and the like. Furthermore, depending upon test conditions, the static coefficient of friction (“stiction”) and/or the dynamic coefficient of friction may be computed.

Substrate 110 may comprise any suitable material, including leather, cloth, simulated skin, or the like. In one embodiment, substrate 110 includes an interchangeable panel on test surface 132 of substrate 110 that contacts product 130. A heating element 112 is incorporated into or otherwise in thermal contact with substrate 130 to provide the desired temperature settings. For example, controller 102 may be configured to maintain heating element 112 at a temperature substantially equal to body temperature (about 98.6° F.).

Linear actuator 120 may be any electromechanical device capable of moving mount assembly 140 in response to commands from 102. Such devices include, for example, conventional stepping motor assemblies, DC motor assemblies, screw-type actuators, and the like. In a particular embodiment, linear actuator 120 comprises a track actuator, as is known in the art.

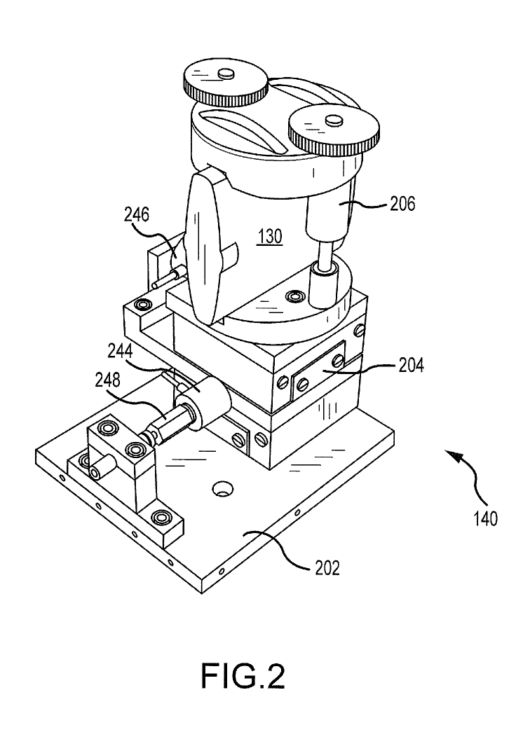

FIG. 2 is an isometric overview of an exemplary mount assembly 140. As shown, the APDO product 130 is held rigidly within a clamp subassembly 206 via screws or other such fasteners. A load cell 244 is used to sense the applied force provided by an air cylinder 248 (corresponding to force sensor 144 of FIG. 1), while a second load cell 246 is used to sense the frictional force produced during test (corresponding to force sensor 146 of FIG. 1). Subassembly 204 is preferably configured to be slideably attached to a base 202, which itself is coupled to the linear actuator 120 of FIG. 1. That is, subassembly 204 may include a linear bearing or the like that allows relatively low-friction movement of clamp assembly 206 along a path parallel to the axis of air cylinder 248 and load cell 244. As mentioned previously, clamp assembly 206 may also be adjustable to allow the orientation of product 130 to be modified (i.e., such that it is non-perpendicular to the substrate 110 during testing).

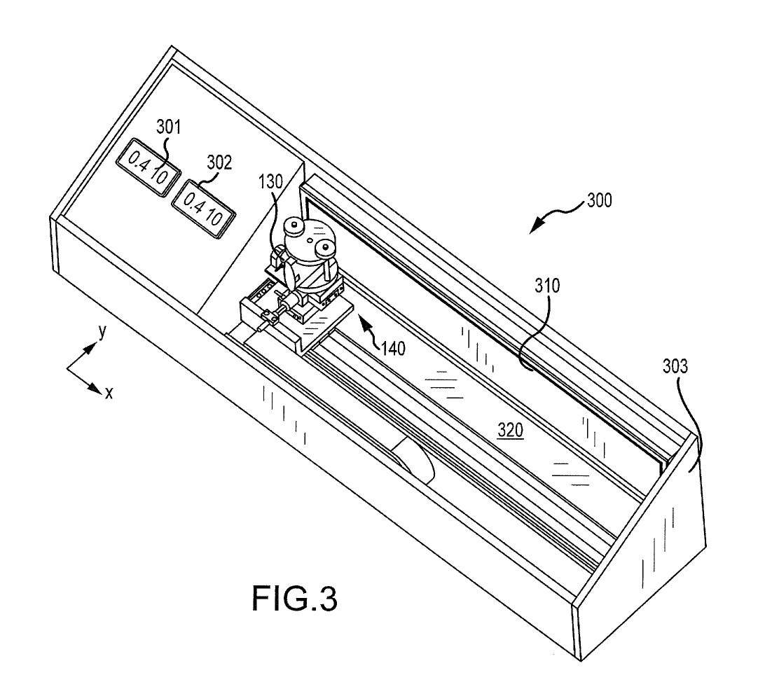

FIG. 3 is an isometric overview of a test apparatus 300 in accordance with one embodiment. As shown, a track actuator 320 is provided within a cabinet 303, which also houses a substrate 310 (functioning as substrate 110 of FIG. 1) that extends substantially the entire length of track actuator 320. Digital readouts 301 and 302 may be provided to show test data in real time, e.g., the values received from force sensors 144 and 146 of FIG. 1. A clear cover (not shown) may be provided to shield the inner components (140, 320, etc.) from an operator during a test sequence. Test apparatus 300 is electrically coupled to the controller of FIG. 1 (as well as any required air supply lines, etc.) in any suitable fashion. Substrate 310 is configured to allow testing of product 130 in connection with a variety of substrate materials. For example, a metal faceplate frame may be provided, wherein the frame can be removed and replaced to clamp the a substrate to the backplate. The metal faceplate frame is held in place by eight bolts or any other such fastener, and there may be a protruding edge on the back of the faceplate that presses the material such that it is held in place. A negative pressure (vacuum) may be pulled through substrate 110 through finely drilled holes to ensure the pressed material does not bunch up or otherwise deform during testing.

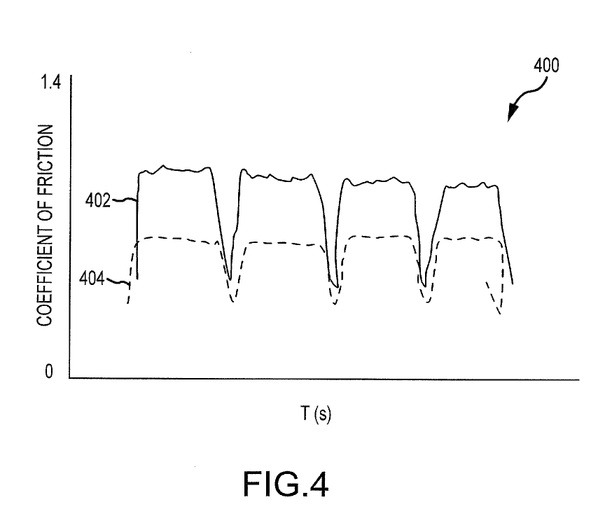

FIG. 4 depicts example graphical output 400 (e.g., for displaying on display 104) for two typical test sequences. In the first test (402), the speed is 0.75 ft/sec, the sample-rate is 0.184 seconds, and the force is 600 g. In the second test (404), the speed is 0.5 ft/sec, the sample-rate is 0.368 seconds, and the force is 800 g. In this graph, the horizontal axis corresponds to time (in seconds), and the vertical axis corresponds to coefficient of friction (a dimensionless parameter). Further, plot 402 relates to a test sequence for one type of APDO product, while plot 404 relates to a test sequence for another type of APDO product. As shown, each plot 402 exhibits a pattern of four regions of maximum coefficient of friction. Each region corresponds to the time that the APDO product is moving with substantially constant velocity across substrate 110, and the brief dips between these regions correspond to the times at which linear actuator 120 is changing direction (i.e., the APDO products were translated back and forth twice). As can be seen, the APDO product of plot 402 shows an overall higher coefficient of friction (μ≈0.8) than the APDO product of plot 404 (μ≈0.5).

As will be apparent, systems and methods in accordance with the present invention allow APDO products to be efficiently and precisely tested at various substrate temperatures, application speeds, product angles, and applied forces.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A friction test system for an antiperspirant/deodorant (APDO) product, comprising:
a substrate having a test surface;
a mount assembly configured to hold the APDO product in contact with the test surface and maintain an applied force between the APDO product and the test surface, the applied force being substantially normal to the test surface;
an actuator configured to move the mount assembly laterally along an axis substantially perpendicular to the applied force during a testing mode;
a force sensor configured to determine a frictional force experienced by the APDO product during the testing mode; and
a processor coupled to the mount assembly, the actuator, and the force sensor, the processor configured to determine a coefficient of friction based on a ratio of the applied force and the frictional force.

2. The friction test system of claim 1, wherein the substrate includes a heating element coupled to the processor, and the processor is configured to maintain the substrate at a predetermined temperature.

3. The friction test system of claim 2, wherein the test surface comprises a material layer that is interchangeably attached to the substrate.

4. The friction test system of claim 1, wherein the mount assembly is configured to rotate such that the orientation of the APDO product with respect to the test surface is selectable.

5. The friction test system of claim 1, wherein the mount assembly is oriented such that the applied force is substantially perpendicular to the force of gravity.

6. The friction test system of claim 1, wherein the processor specifies a plurality of test settings for the testing mode, the test settings including at least a speed of the mount assembly and a magnitude of the applied force.

7. The friction test system of claim 1, wherein:
the mount assembly includes an air cylinder coupled to a second force sensor; and
the processor is coupled to the air cylinder and the second force sensor, and is configured to control the air cylinder based on feedback from the force sensor.

8. The friction test system of claim 7, wherein the mount assembly includes a linear bearing and a base, the linear bearing allowing the mount assembly to slideably move along an axis parallel to the applied force with respect to the actuator.

9. A method for determining the coefficient of friction of an antiperspirant/deodorant (APDO) product, the method comprising:
selectably securing a test surface to a test substrate;
holding the APDO product in contact with the test surface;
maintain an applied force between the APDO product and the test surface such that the applied force is substantially normal to the test surface;
moving the APDO product laterally along an axis substantially perpendicular to the applied force;
determining a frictional force experienced by the APDO product while the APDO product is moved laterally; and
determining the coefficient of friction based on a ratio of the applied force and the frictional force.

10. The method of claim 9, further including maintaining the substrate at a predetermined temperature.

11. The method of claim 9, further including selectably setting the orientation of the APDO product with respect to the test surface.

12. The method of claim 9, further including maintaining the applied force substantially perpendicular to the force of gravity.

13. The method of claim 9, further including specifying a plurality of test settings for the testing mode, the test settings including at least a speed of the mount assembly and a magnitude of the applied force.

14. The method of claim 9, further including:
providing an air cylinder coupled to a force sensor such that the air cylinder maintains the applied force and the force sensor is senses the applied force; and
controlling the air cylinder based on feedback from the force sensor.

15. The method of claim 9, providing a linear bearing and a base, wherein the linear bearing allows the APDO product to slideably move along an axis parallel to the applied force.

16. The method of claim 9, further including displaying a graphical representation of the coefficient of friction.

17. A mount assembly for friction testing an antiperspirant/deodorant (APDO) product, comprising:
a base;
a clamp assembly coupled to the base and configured to grasp the APDO product;
a force actuator for maintaining an applied force between the APDO product and a test surface such that the applied force is substantially normal to the test surface and substantially perpendicular to the force of gravity;
a linear bearing coupled between the base and the clamp assembly, the linear bearing allowing movement of the clamp assembly with respect to the base along an axis parallel to the applied force;
a first force sensor configured to determine a frictional force experienced by the APDO product as it is moved with respect to the test surface; and
a second force sensor configured to measure the applied force produced by the force actuator.

18. The mount assembly of claim 17, wherein the first and second force sensors are load cells.

19. The mount assembly of claim 17, wherein the force actuator is an air cylinder.

20. The mount assembly of claim 17, wherein the force actuator and the second force sensor are substantially coaxial.
